(19) United States
(12) Patent Application Publication
(10) Pub. No.: US 2026/0251539 A1
(43) Pub. Date: Aug. 27, 2026

(54) Simple Method For Isolating Immune Cells From The Lamina Propria Of Mouse Intestinal Tissue

(71) Applicant: Jinzhou Medical University, Jinzhou (CN)

(72) Inventor: Qingjie Fan, Chuzhou (CN)

(21) Appl. No.: 19/061,197

(22) Filed: Feb. 24, 2025

(51) Int. Cl. G01N 1/30; G01N 1/28; G01N 1/34; G01N 1/40

(52) U.S. Cl. CPC G01N 1/30; G01N 1/286; G01N 1/34; G01N 1/4044; G01N 1/4077; G01N 2001/2873; G01N 2001/4088

(57) ABSTRACT

The present invention provides simple method for isolating immune cells from the lamina propria of mouse intestinal tissue, belonging to the field of biotechnology. This simple method for isolating immune cells from the lamina propria of mouse intestinal tissue includes selecting 6-week-old mice. After being raised in a specific environment, the mice are anesthetized and intestinal tissue is taken. The intestinal tissue is washed with precooled PBS and cut into small segments. The digestion solution containing a specific concentration of collagenase VIII and DNase I is incubated at 37° C. and a specific pH value with gentle shaking. After digestion, the solution is filtered through a 70 μm cell sieve and centrifuged at 300×g. The immune cell suspension is obtained by resuspending with PBS buffer and then purified with Percoll medium and resuspended with RPMI1640 medium containing serum, etc.

### TECHNICAL FIELD

The present invention belongs to the field of biotechnology, and specifically relates to simple method for isolating immune cells from the lamina propria of mouse intestinal tissue.

### BACKGROUND OF THE PRESENT INVENTION

In the field of biotechnology, especially in the research of immune cells in the lamina propria of mouse intestinal tissue, the isolation of immune cells is a key step. In existing technologies, when isolating immune cells from the lamina propria of mouse intestinal tissue, multiple cumbersome steps and a variety of complex instruments and equipment are involved. For example, in the sample acquisition stage, a complex pretreatment process may be required. In the cell separation process, multiple different reagents and instruments may need to cooperate. The operation process is long and complex, and the operation skills of experimenters are highly demanded. Professional training is required to master it proficiently.

To solve these problems, this utility model patent provides simple method for isolating immune cells from the lamina propria of mouse intestinal tissue. This method aims to simplify the operation process, reduce the dependence on complex instruments and equipment, improve the cell yield and purity at the same time, and shorten the time required for the separation process, so as to better meet the needs of immunological research.

### SUMMARY OF PRESENT INVENTION

The purpose of the present invention is to provide simple method for isolating immune cells from the lamina propria of mouse intestinal tissue, aiming to solve the problems in the prior art that traditional methods are complex in operation, require multiple cumbersome steps and complex instruments, increase costs and have high requirements for personnel skills. They are time-consuming, and the cell yield and purity are not ideal, making it difficult to meet the needs of immunological research for high-quality cell samples.

To achieve the above purpose, the present invention provides the following technical solutions:

Simple method for isolating immune cells from the lamina propria of mouse intestinal tissue is characterized by comprising the following steps:
Step 1: Select healthy 6-week-old mice and adaptively raise them for 3 days. The rearing environment temperature is 22° C. to 25° C., and the relative humidity is 40% to 60%. Intraperitoneal injection anesthesia is performed with pentobarbital sodium at a dose of 50 milligrams per kilogram of body weight. Under sterile conditions, take out the intestinal tissue and put it into precooled sterile PBS solution for washing 3 times to remove intestinal contents. During the washing process, the temperature of the PBS solution is maintained at 4° C.
Step 2: Cut the washed intestinal tissue into 1.5-centimeter segments and put them into a digestion solution containing 1 milligram/milliliter of collagenase VIII and 0.1 milligram/milliliter of DNase I. The pH value of the digestion solution is 7.2 to 7.4. Put the small segments of intestinal tissue into this solution and incubate at a constant temperature of 37° C. for 40 minutes to fully digest the intestinal tissue. During the incubation process, maintain gentle shaking at a shaking frequency of 50 to 60 times per minute.
Step 3: Filter the digested intestinal tissue suspension through a 70 μm cell sieve. Collect the filtered cell suspension and centrifuge it at a centrifugal force of 300×g for 5 minutes. After removing the supernatant, resuspend with PBS buffer to obtain an immune cell suspension. The osmotic pressure of the PBS buffer is 280 to 300 milliosmoles/liter.
Step 4: Purify the immune cell suspension by density gradient centrifugation using Percoll medium with a density of 1.080 grams/milliliter. During the centrifugation process, the acceleration and deceleration of the centrifuge are both set to 5 gears per minute. Collect the purified immune cells and resuspend them with RPMI1640 medium for standby. RPMI1640 medium is supplemented with 10% fetal bovine serum and 1% penicillin-streptomycin solution.
Step 5: During the entire separation process, all the experimental instruments used need to be sterilized by high-pressure steam. The sterilization temperature is 121° C., and the time is 20 minutes to ensure a sterile environment during the experiment.
Step 6: After the immune cells are separated, the cells should be counted and viability tested. The blood cell counting chamber method can be used for cell counting, and the trypan blue staining method can be used for viability testing to ensure that the separated immune cells have high viability and quantity.

Compared with the prior art, the beneficial effects of the present invention are as follows:
1. In this scheme, by clearly stipulating the specific operation conditions of each step, such as selecting mice of a specific age (6 weeks old), using a unified anesthetic and dose (pentobarbital sodium, 50 milligrams per kilogram of body weight), and detailed specifications for intestinal tissue treatment (cutting into 1.5-centimeter segments and incubating at 37° C. for 40 minutes in a specific digestion solution, etc.), the entire operation process is standardized and easy to understand. Experimenters can operate according to detailed steps and complete it without complex professional skill training, reducing the requirements for operators.

It reduces the dependence on complex instruments and equipment. Although some basic instruments such as centrifuges and cell sieves are still needed, the requirements for the precision and complexity of instruments are reduced. At the same time, by optimizing the use of reagents, such as clearly defining the enzyme concentration in the digestion solution (collagenase VIII concentration is 1 milligram/milliliter, and DNase I concentration is 0.1 milligram/milliliter), etc., unnecessary reagent waste is avoided, thereby reducing experimental costs and enabling more laboratories to carry out related experiments.
2. In this scheme, due to the simplified operation process and clear time for each step (such as digestion time is 40 minutes and centrifugation time is 5 minutes, etc.), the entire separation process takes relatively less time. From obtaining mouse intestinal tissue to obtaining available immune cells, it can be completed in a relatively short time, improving experimental efficiency and enabling researchers to obtain the cell samples needed for experiments more quickly and speeding up the research progress.
3. In this scheme, in terms of cell yield, by optimizing digestion conditions (suitable digestion solution composition and incubation conditions) and filtration and centrifugation conditions (filtering through a 70 μm cell sieve and centrifuging at a centrifugal force of 300×g for 5 minutes, etc.), cell loss is reduced and cell yield is improved. In terms of purity, density gradient centrifugation method (Percoll medium with a density of 1.080 grams/milliliter) is used to purify the immune cell suspension, effectively removing impurity cells and improving the purity of immune cells, meeting the needs of immunological research for high-quality cell samples and helping to improve the accuracy of subsequent experimental results.

### DETAILED DESCRIPTION OF THE EMBODIMENTS

The following will describe the technical solutions in the embodiments of the present invention clearly and completely in combination with the embodiments of the present invention. Obviously, the described embodiments are only some embodiments of the present invention, not all embodiments. Based on the embodiments of the present invention, all other embodiments obtained by those of ordinary skill in the art without creative efforts fall within the protection scope of the present invention.

### Example 1

The present invention provides the following technical solutions:

Simple method for isolating immune cells from the lamina propria of mouse intestinal tissue is characterized by comprising the following steps:
Step 1: Select healthy 6-week-old mice and adaptively raise them for 3 days. The rearing environment temperature is 22° C. to 25° C., and the relative humidity is 40% to 60%. Intraperitoneal injection anesthesia is performed with pentobarbital sodium at a dose of 50 milligrams per kilogram of body weight. Under sterile conditions, take out the intestinal tissue and put it into precooled sterile PBS solution for washing 3 times to remove intestinal contents. During the washing process, the temperature of the PBS solution is maintained at 4° C.
Step 2: Cut the washed intestinal tissue into 1.5-centimeter segments and put them into a digestion solution containing 1 milligram/milliliter of collagenase VIII and 0.1 milligram/milliliter of DNase I. The pH value of the digestion solution is 7.2 to 7.4. Put the small segments of intestinal tissue into this solution and incubate at a constant temperature of 37° C. for 40 minutes to fully digest the intestinal tissue. During the incubation process, maintain gentle shaking at a shaking frequency of 50 to 60 times per minute.
Step 3: Filter the digested intestinal tissue suspension through a 70 μm cell sieve. Collect the filtered cell suspension and centrifuge it at a centrifugal force of 300×g for immune cell suspension. The osmotic pressure of the PBS buffer is 280 to 300 milliosmoles/liter.
Step 4: Purify the immune cell suspension by density gradient centrifugation using Percoll medium with a density of 1.080 grams/milliliter. During the centrifugation process, the acceleration and deceleration of the centrifuge are both set to 5 gears per minute. Collect the purified immune cells and resuspend them with RPMI1640 medium for standby. RPMI1640 medium is supplemented with 10% fetal bovine serum and 1% penicillin-streptomycin solution.
Step 5: During the entire separation process, all the experimental instruments used need to be sterilized by high-pressure steam. The sterilization temperature is 121° C., and the time is 20 minutes to ensure a sterile environment during the experiment.
Step 6: After the immune cells are separated, the cells should be counted and viability tested. The blood cell counting chamber method can be used for cell counting, and the trypan blue staining method can be used for viability testing to ensure that the separated immune cells have high viability and quantity.

In the specific embodiments of the present invention,

Select 6-week-old C57BL/6 mice and sacrifice them after intraperitoneal injection anesthesia with pentobarbital sodium at a dose of 50 milligrams per kilogram of body weight.

Under sterile conditions, quickly take out the small intestinal tissue of the mice and put it into precooled sterile PBS solution for washing 3 times to remove intestinal contents. During the washing process, ensure that the temperature of the PBS solution is 4° C.

Cut the washed small intestinal tissue into 1.5-centimeter segments and put them into a digestion solution containing collagenase VIII (concentration of 1 milligram/milliliter) and DNase I (concentration of 0.1 milligram/milliliter). Adjust the pH value of the digestion solution to 7.3. Incubate at 37° C. for 40 minutes. During the incubation process, maintain gentle shaking at a shaking frequency of 55 times per minute.

After digestion, add an appropriate amount of medium containing 10% serum to terminate the digestion reaction.

Filter the digested small intestinal tissue suspension through a 70 μm cell sieve to remove undigested tissue fragments.

Collect the filtered cell suspension and centrifuge it at a centrifugal force of 300×g for 5 minutes to remove the supernatant.

Resuspend the precipitated cells with an appropriate amount of PBS buffer. The osmotic pressure of the PBS buffer is 290 milliosmoles/liter to obtain the immune cell suspension from the lamina propria of mouse intestinal tissue.

Purify the immune cell suspension by density gradient centrifugation using Percoll medium with a density of 1.080 grams/milliliter. During the centrifugation process, the acceleration and deceleration of the centrifuge are both set to 5 gears per minute.

Collect the purified immune cells and resuspend them with an appropriate amount of RPMI1640 medium. RPMI1640 medium is supplemented with 10% fetal bovine serum and 1% penicillin-streptomycin solution for standby.

Perform counting and viability detection on the separated immune cells. Use the blood cell counting chamber method for cell counting and the trypan blue staining method for viability detection.

1. Simple method for isolating immune cells from the lamina propria of mouse intestinal tissue is characterized by comprising the following steps:
step 1: Select healthy 6-week-old mice and adaptively raise them for 3 days; the rearing environment temperature is 22° C. to 25° C.; and the relative humidity is 40% to 60%; intraperitoneal injection anesthesia is performed with pentobarbital sodium at a dose of 50 milligrams per kilogram of body weight; under sterile conditions; take out the intestinal tissue and put it into precooled sterile PBS solution for washing 3 times to remove intestinal contents; during the washing process; the temperature of the PBS solution is maintained at 4° C.;
step 2: Cut the washed intestinal tissue into 1.5-centimeter segments and put them into a digestion solution containing 1 milligram/milliliter of collagenase VIII and 0.1 milligram/milliliter of DNase I; the pH value of the digestion solution is 7.2 to 7.4; Put the small segments of intestinal tissue into this solution and incubate at a constant temperature of 37° C. for 40 minutes to fully digest the intestinal tissue; during the incubation process; maintain gentle shaking at a shaking frequency of 50 to 60 times per minute;
step 3: Filter the digested intestinal tissue suspension through a 70 μm cell sieve;
collect the filtered cell suspension and centrifuge it at a centrifugal force of 300×g for 5 minutes; after removing the supernatant; resuspend with PBS buffer to obtain an immune cell suspension; the osmotic pressure of the PBS buffer is 280 to 300 milliosmoles/liter;
step 4: Purify the immune cell suspension by density gradient centrifugation using Percoll medium with a density of 1.080 grams/milliliter; during the centrifugation process; the acceleration and deceleration of the centrifuge are both set to 5 gears per minute; collect the purified immune cells and resuspend them with RPMI1640 medium for standby; RPMI 1640 medium is supplemented with 10% fetal bovine serum and 1% penicillin-streptomycin solution;
step 5: During the entire separation process; all the experimental instruments used need to be sterilized by high-pressure steam; the sterilization temperature is 121° C.; and the time is 20 minutes to ensure a sterile environment during the experiment;
step 6: After the immune cells are separated; the cells should be counted and viability tested; the blood cell counting chamber method can be used for cell counting; and the trypan blue staining method can be used for viability testing to ensure that the separated immune cells have high viability and quantity.
